(19) United States
(12) Patent Application Publication
(10) Pub. No.: US 2008/0202808 A1
(43) Pub. Date: Aug. 28, 2008

(54) Method For Ethernet and Electric Power Cabling

(76) Inventor: Mohan Tambe, Mumbai (IN)

Correspondence Address: GREENBLUM & BERNSTEIN, P.L.C., 1950 ROLAND CLARKE PLACE, RESTON, VA, 20191, US

(21) Appl. No.: 12/065,698

(22) PCT Filed: Sep. 4, 2006
(86) PCT No.: PCT/IN06/00335

§ 371 Date: Mar. 4, 2008

(30) Foreign Application Priority Data
Sep. 5, 2005 (IN) 1079/MUM/2005

(51) Int. Cl. H02G 3/00

(52) U.S. Cl. 174/504

(57) ABSTRACT

Present invention outlines a structured wiring methodology for installing a premise-wide distributed Ethernet LAN (Local Area Network) featuring Broadband Points with Power-over-Ethernet (PoE) and Electrical Sockets, allowing connection to Broadband Appliances. The necessary LAN and electrical cabling stays entirely within a Beading (or Casing and Capping), which recursively loops along the skirting level of the walls within the premise. This does not disturb the aesthetics of an existing premise, as the Beading merges with the skirting outline, or can be concealed within the wall itself. Each end of the looped Beading can be terminated on a dual Broadband Gateway, which provides WAN and global Internet connectivity. The looped Beading provides immunity against a single failure of Electronic boards (within Broadband Points or Gateway) or single cut in the cables. Ethernet connection cord can be as thin and flexible as that in telephones, and thinner than that for USB appliances. Furthermore, at the appliance end it is possible to use a tiny RJ-11 plug (used in telephones), which can get embedded within the appliance itself, instead of the traditional RJ-45 plug, which is bigger. The thin connection cord and the tiny RJ-11 plug, is more compact than the USB cord and connector, and doesn't have the latter's restriction of length and the available DC power. The Broadband appliances thus can tap the full bandwidth of 100 MB Ethernet, while not compromising on handling and ergonomic aspects.

### FIELD OF INVENTION

The present invention relates to network infrastructure and more particularly to a method of cabling a premise-wide wiring system for systematically covering each and every room and locating broadband points anywhere in the premise.

### BACKGROUND OF THE INVENTION

In the early days of electrical infrastructures, there was a need present for wiring up each room and corridor of the house so that bulbs, fans etc. could be used wherever required. There was a need, from the beginning, to provide electrical sockets in every room for connecting to electric appliances such as heaters, table lamps etc.

The electric wiring, till quite recently was exposed, and done in quite an ad-hoc manner, depending on the perceived needs at the time of installation. As a result, over the years, as the need for connecting to new appliances such as air-conditioners and tube-lights emerged, a lot of retrofit wiring was required. The few sockets planned originally turned out to be inadequate and people had to use electric extension boards to connect more appliances.

In recent times, new homes are built with concealed electric wiring. However, the residents have to limit themselves to the light points and power sockets as originally visualized by the builder, or else resort to exposed, retrofit wiring. The concealed wiring did nothing to systematize or structure the wiring methodology—it just hid the expedient wiring inside the walls. Any subsequent change to the concealed wiring was therefore unthinkable.

The present times can be considered as the early days for emergence of the broadband infrastructure, similar to that of electric infrastructure in its infancy. The situation is, however, worse as there is no perceived need for Broadband appliances in each room: unlike the need for an electric bulb. Therefore, there doesn't seem to be a need for comprehensive wiring, for connecting to Ethernet sockets in each and every room.

Existing Ethernet wiring is mostly confined to offices with multiple computers. These are wired using the “structured LAN wiring” technique for Ethernet. This requires a centralized wiring cabinet with one or more Ethernet Switches. A separate CAT-5 cable is taken from the hub here to different rooms where Ethernet sockets are required. The wiring can be done in a concealed manner using false flooring or ceilings, or through concealed conduits on the walls. Exposed Casing & Capping becomes necessary when retrofitting in existing premises.

The traditional structured LAN wiring cost can be quite high, making it unaffordable for residential usage. An additional problem in modern homes is that of the neat interiors with concealed wiring for electricity, telephone and cable-TV. These modern homes would not like any retrofit exposed wiring to spoil up the decor.

As of now, Ethernet sockets are mostly used for connecting Personal Computers on a LAN and allowing them to access each other as well as the Internet. The Internet connection is provided mostly through Telephone, Cable or ADSL modems. More recently, high-speed Internet connection is available through Ethernet Gateways, connected to a fiber-based Broadband network. The Broadband network also provides bandwidth intensive services such as Digital TV Channels and Video-on-Demand, apart from timing sensitive services such as Digital Telephony. This opens up avenues for a variety of Broadband Appliances to emerge, which can tap host of services through the Broadband networks. Examples are:

Personal Digital Assistants (PDA), Set-top-boxes, Video Games, Digital TV, VoIP, Phones, Smart Home Controller and Devices, Picture/Video Camera, Active Photo Frames, Digital Walkman, Video Conferencing, Digital Radio, Digital, speakers for Surround Sound, WiFi Access point, Dongle for connecting to USB appliances, Dongle for connecting to POTS phone etc.

Thus, instead of professional Ethernet equipment (such as PCs), the age of consumer-friendly Broadband appliances would emerge. A whole new Broadband ecology would emerge, if Ethernet sockets with Power-over-Ethernet were available all over a premise, and people could plug in a multitude of Ethernet Appliances which would communicate to other Ethernet appliances in the premise as well as on the Internet. The major problems associated with the presently known methods of wiring are their connection complexities, requirement of networking expertise, poor scalability and high entry costs. The vexing problem of how to wire up all the premises in any city, has to be solved, for this new Broadband ecology to emerge.

Therefore, there is a need to facilitate the emergence of Ethernet Appliances. For instance, most of the appliances would benefit, if adequate DC power (less than 15 watts) was also available through the Ethernet socket itself. The higher wattage broadband appliances would of course benefit from Electrical sockets being co-located along with the Ethernet sockets itself.

Further, there is a need for a “Broadband Point”, taking care of the requirements of Ethernet Points with Power-over-Ethernet over them. More over, the Broadband Point could also have on its side an Electrical Point. Alternatively, Electrical Points can be co-located along with the Broadband Points itself.

There is also a need for Broadband Appliances being connected to a nearby Broadband Point using a chord, which is as thin and flexible as that used in telephones. Furthermore, the appliance end connector is a tiny one (RJ-11), which can get concealed in the appliance itself.

Another drawback of the existing electrical infrastructure, inside a premise is its fail-safe infrastructure where any loose contact, a cut wire or a blown fuse, can bring down the appliances connected to it. Therefore there is also a need for a methodology that always ensures an alternate path available for the signals in case of any failure.

### SUMMARY OF THE INVENTION

The object of the present invention is therefore to provide a network infrastructure, which would become as ubiquitous as the electrical infrastructure, while being much simpler to install.

Another object of the present invention is to provide cabling within a premise without disturbing the beauty of the existing interiors, and spoiling the looks of the walls with cabling and sockets.

A further object of the present invention is to provide a premise-wide wiring system, which systematically covers each and every room, and to provide an optimal way for wiring the entire premise thereby saving a lot of energy in evaluating different options.

Another object of the present invention is to locate Broadband Points anywhere in the premise, and to meet reasonable power requirements of Ethernet Appliances (<15 W), without requiring a separate connection to an Electrical Point.

Yet another object of the present invention is to allow a common DC powering of all the Broadband Points and Broadband Appliances.

A still further object of the present invention is to provide a scheme, which allows all interconnect cables to be concealed within walls, and the Broadband points to be flush with the walls themselves.

A further object of the present invention is to provide a scheme, whereby one “active” Broadband Point, can connect to Ethernet sockets on the neighboring “passive” Broadband Points.

In carrying out the above objects, a methodology is provided for Ethernet and electrical cabling comprising the steps of: providing wiring to a premise through an entry point; providing wiring in each room of the premise at a skirting level; wiring leaving the premise through the entry point; wherein said wiring includes at least a pair of Ethernet cable and at least a pair of electrical cable forming a recursive loop beading thereby enabling installation of Ethernet and electrical appliances at any point and emerging need.

As per the present invention, the looped beading includes at least one Broadband Point that can be increased to any number thereby forming a chain of broadband points, on a just-in-time basis, without requiring any additional cabling. Said broadband point includes at least one Power over Ethernet socket, a passive Printed Circuit Board (PCB) and an active PCB.

The methodology of Ethernet and electrical cabling further comprises the steps of: cutting the cable at the center of said Broadband Point; and inserting the bare ends of the cable on terminals on the two sides of a “Connection-strip” to be plugged into said Active or Passive PCB. The cable can also be passed through a dummy Broadband Point without having any PCB or sockets.

The method for Ethernet and electrical cabling further comprises the steps of supporting at least two sockets on Passive PCBs of the two adjacent Broadband Points, by said Active PCB, in addition to its own Ethernet sockets, without using any additional cable for connections.

The present invention discloses the method for Ethernet and electrical cabling, wherein said Ethernet cable further includes a 48V DC loop being powered by DC adaptors attached at one or more Broadband Points, for supplying power to said Power-over-Ethernet (PoE) sockets and the Active PCBs in the Broadband Points. Said looped beading also includes an AC power loop, tapping power from the AC Mains of the premise for powering any Electric sockets adjacent to the Broadband Points via a Miniature Circuit Breaker (MCB) or a Switch.

The method for Ethernet and electrical cabling further comprises the steps of: extending said chain of Broadband Points; and terminating on a Dual Gateway, located outside the premise thereby providing immunity against a single failure of a Gateway, a Broadband Point or a UTP cable link. Said Dual Gateway is powered solely from the 48V DC loops of the premises for keeping the Dual Gateway “ON” as long as any of its premises is “ON”.

The method for Ethernet and electrical cabling further comprises the steps of: mounting the electrical sockets upside-down for preventing the Ethernet and electrical cables coming from adjacent table-top appliances, hanging on the floor.

The method for Ethernet and electrical cabling further comprises the steps of: guiding said Ethernet and electrical cables to any Ethernet Point using a transparent “cable manager”.

As per the present invention, a method for Ethernet and electrical cabling is provided wherein, on the looped Beading, only alternate Broadband Points need to have Active PCB, the others can be Passive PCBs with one or two Ethernet Sockets. Whenever a Broadband Point is inserted, the Active and Passive PCBs can be shuffled within the Broadband Points to preserve the alternating sequence.

Other objects, features and advantages of the invention will be apparent from the drawings, and from the detailed description that follows below.

### BRIEF DESCRIPTION OF DRAWINGS

FIG. 1 is the schematic view of a connection of a premise to gateway via premise Box according to the present invention.

FIG. 2 is an illustration of Looped Beading inside a Hall of a house.

FIG. 3 illustrates the Looped Beading Entering to and reemerging from a room through a Door Frame.

FIG. 4 shows the Looped Beading entering/exiting a Room from respective holes in the door frame at the skirting level.

FIG. 5 shows the Beading skipping a room, such as a bathroom, over the door frame.

FIG. 6 shows termination of a UTP cable on a Connection Strip according to the present invention.

FIG. 7 is an illustration of an Active PCB inside a Broadband Point as per the present invention

FIG. 8: is an illustration of Passive PCB inside a Broadband Point as per the present invention

FIG. 9 depicts Powering the Broadband Points

FIG. 10 is the schematic view of inserting an Electrical Point according to the present invention

FIG. 11 is the schematic represention of Powering the Electrical Points

FIG. 12 represents the terminations inside a Premise Box

FIG. 13 shows how the Active PCB supports the adjacent Passive PCBs according to the present invention.

FIG. 14 illustrates a Recursively Looped Beading Covering the Entire Premise according to the present invention.

FIG. 15 is the diagrammatical representation of a Cable Manager.

### DETAILED DESCRIPTION OF THE PREFERRED EMBODIMENTS

In the following description, specific details are set forth in order to provide an understanding of the invention. Reference in the specification to “one embodiment,” “a preferred embodiment” or “an embodiment” means that a particular feature, structure and characteristic, or function described in connection with the embodiment is included in at least one embodiment of the invention. The appearance of the phrase “an embodiment,” “in embodiment,” or the like in various places in the specification are not necessarily all referring to the same embodiment.

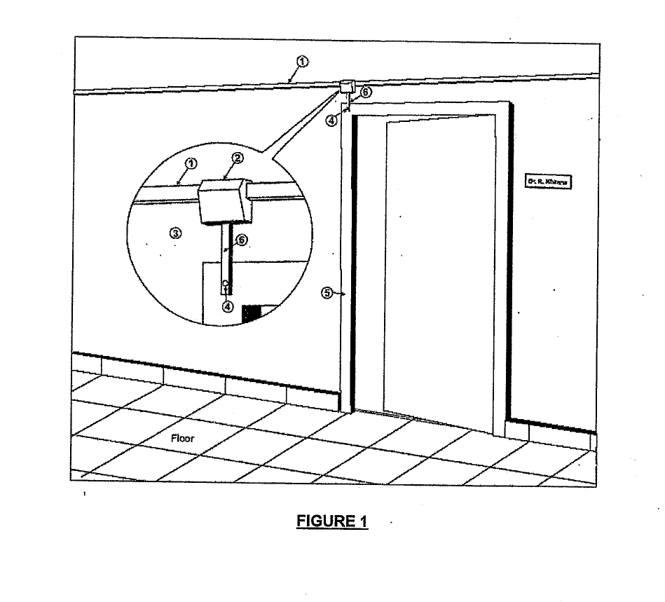

In an embodiment of the present invention, FIG. 1 shows a Premise Box (2) located on a Casing/Capping (1) coming from an external Gateway. The Premise Box is directly above the front door (5) of a Premise. A Beading (6) emerges from the Premise Box and enters the Premise through a hole (4) in the main door frame (5). This results in the interiors of a premise with a neat skirting level (7) on each wall and few inches above the floor. This skirting level (7) is prominent and well defined. It is possible to lift the skirting level (7) by half an inch by adding, what looks like a decorous “Beading” (6). The skirting level (7) is maintained even when the Beading (6) passes through a doorframe to another room. Sometimes the Beading (6) needs to climb over a doorframe, to come down to the skirting level (7) on the other side.

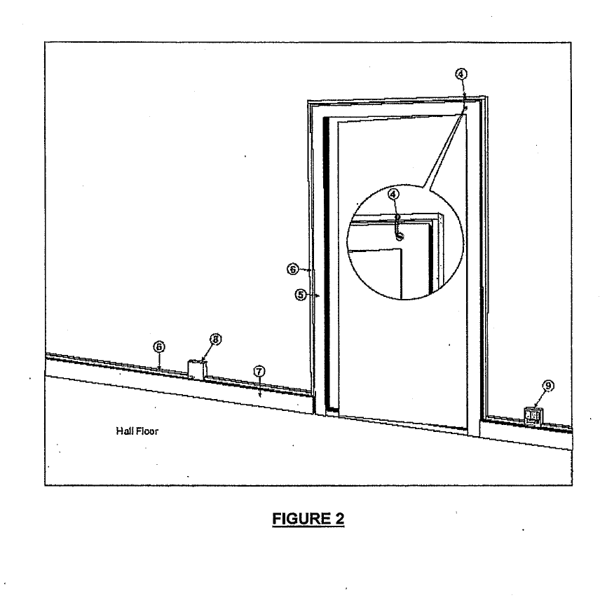

Referring now to FIG. 2, the looped beading inside a hall of a house is implemented in a similar way as described for FIG. 1. FIG. 2 shows how the Beading (6) from outside of the Premise enters into a hall through a hole (4) in the main doorframe (5), and then connects to the looped Beading (6) inside. The looped Beading (6) travels around the edges of the main door frame (5), till the skirting level (7). Broadband Points (8) and Electrical Points (9) are inserted anywhere on the Beading at the skirting level (7).

In the existing electrical infrastructure, the interiors get spoiled many times, when existing cabling has to be modified to accommodate newer requirements and additional cables have to be laid, which spoil the looks of any interior. It is also not possible to anticipate all the different requirements, which would emerge in the future. The present invention solves all these problems, by providing a unique way of recursively looping through the entire premise and coming back to the main door of the premise. The invention allows starting with a few Broadband Points, knowing that additional can be added as and when needed.

In an alternate embodiment it is also possible to camouflage by using a wooden Beading matching the doorframe while the Broadband Points are kept at the skirting level, such that they don't spoil the looks of the walls.

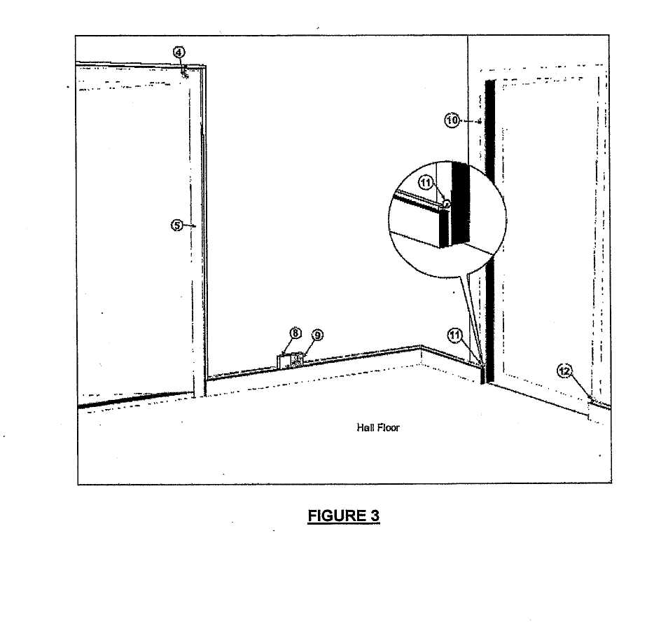

In an another embodiment of the present invention, FIG. 3 shows how the Beading enters a room door frame (10) at the skirting level (7) from one side of the door frame (11), and then re-emerges at the skirting level (7) from other side of the door frame (12). In this manner the intervening doors in the hall are traversed till the beading comes back to the main door frame (5). Thus, premise wide Broadband/Electrical Points are now possible without any pre-planning and indeed without requiring any network diagrams.

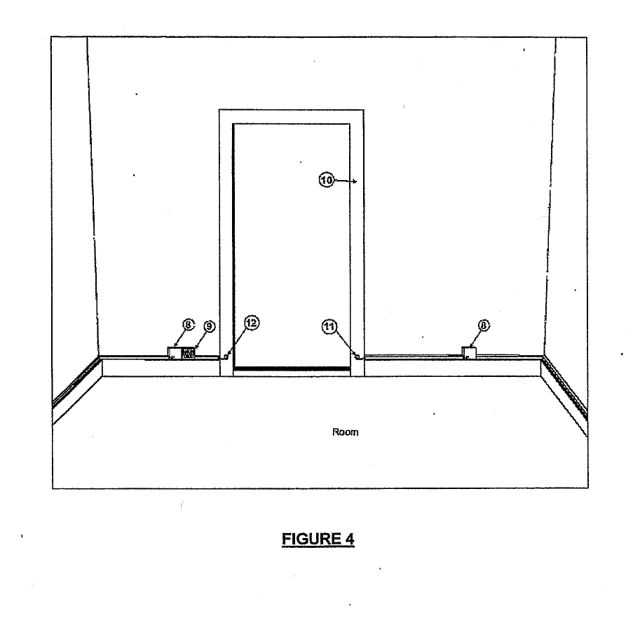

Further, the present invention discloses the method of Looped Beading inside a Room with the help of FIG. 4, which shows how the Beading enters a room from a hole (11) in the door frame (10) at the skirting level and then traverses the entire room, in a manner similar to that of the hall in FIG. 3, and exits from the same door it entered, at the skirting level (12), although from the different side of the door frame (10).

The ultimate enhancement lies, in concealing the Beading (6) and the Broadband/Electrical Points (8 & 9) within the walls itself, just above the skirting level (7). This is achieved by making a half-inched grove just above the skirting (7) and burying the beading (6) within it. The Broadband/Electrical Points (8 & 9) are also buried with only their front panel visible. Since the concealed Beading is just below the surface of the wall, it is always possible to insert a Broadband/Electrical Point (8& 9) later on. Newer constructions would go for concealed Beading with few Broadband Points. Additional Broadband Points can be inserted later on as required.

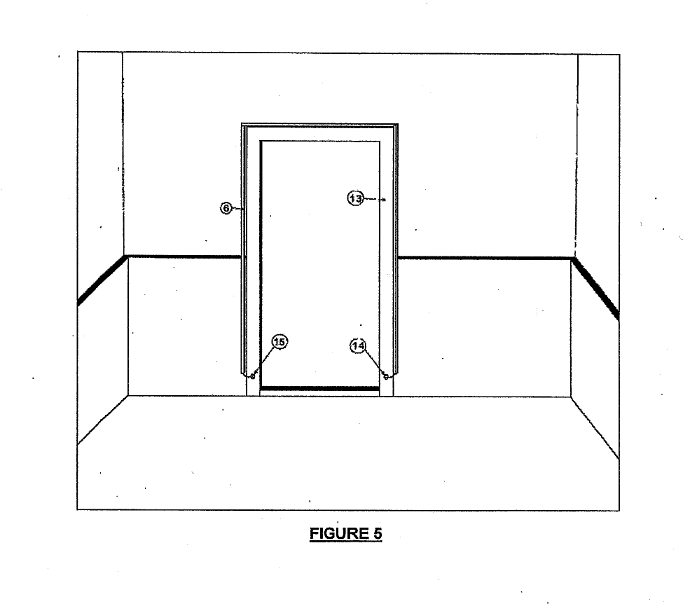

One first has to just lay the looped Beading in a recursive manner, such that it covers the entire premise, and comes back to the main door from which it started. There is not much scope for planning in this, except whether one would like to skip the bathrooms as shown in FIG. 5, or have them girdled too. The figure shows how the Beading can skip a room, by simply traversing over the door frame (13) from which it entered (14), and directly exiting out from the other side (15).

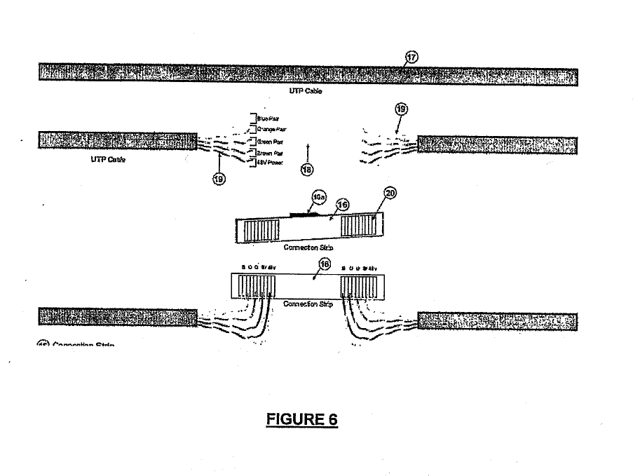

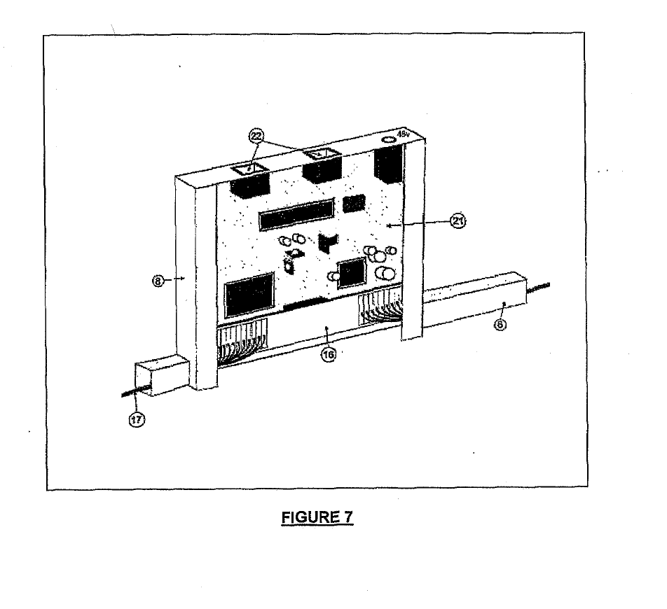

After that, it is a simple exercise, to figure out where one wants the initial Broadband/Electrical Points to be located. Perhaps at one or two locations in each room. This exercise, can be done without worrying about the cost involved for all the Broadband Points, simply because right in the beginning they can be just empty Broadband Points. FIG. 6 shows how a Connection Strip (16) inside a Broadband Point is connected to the UTP cable (17). The UTP cable is split at the centre (18), and the 5 pairs of wire (19) at each end are connected to the Snap terminals (20) on the Connection Strip on the respective side. Connection Strip has a plug (16a) on the back side, for allowing it to be plugged into a PCB. An empty Broadband Point, has only a “Connection Strip” within it—on which the two ends of a split UTP cable (17) are terminated (all the five pairs). Initially, the Connection Strip allows the UTP connection to simply “pass-through”, as if the cable wasn't split at all. Subsequently, when one requires, an Active or Passive PCB can be inserted inside the Broadband Point and attached to the Connection Strip. As can be seen from FIG. 7, the Connection Strip (16) can be mounted on an Active PCB (21), which has electronics and two Ethernet sockets (22). The Beading (6) is cut inside the Broadband Point (8) to allow the the connections to be made.

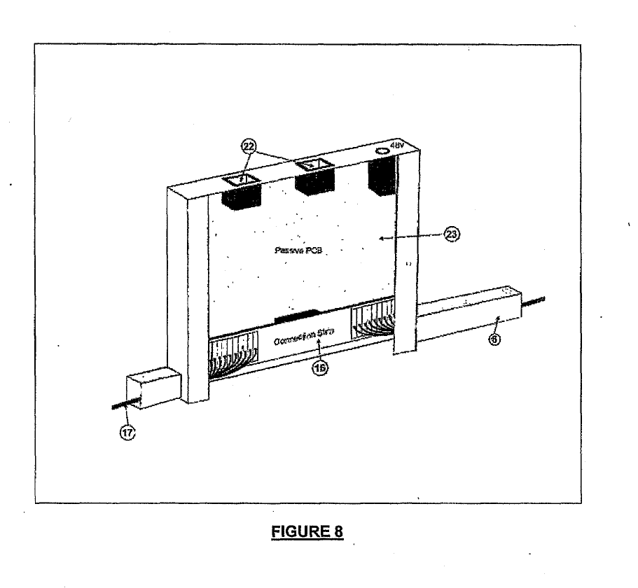

Thus, there is really no initial financial commitment required for figuring out locations for empty Broadband Points for doing future justice. The actual insertion of an Active/Passive PCB in an empty Broadband Point, can be done on just-in-time basis, without even having to call an Electrician. This is shown in FIG. 8. The figure shows how the Connection Strip (16) can be mounted on a Passive PCB (23) which has no electronics but two Ethernet sockets (22).

The cost effectiveness, becomes even more drastic since it is only necessary to equip only alternate Broadband Points with Active PCBs: the others can have “Passive PCBs” with one or two Ethernet Sockets which get supported through the Active PCBs of the adjacent Broadband Points. The Passive PCB, locally injects the 48V power, required for Power-over-Ethernet (PoE) to both of its sockets.

Thus only alternate Broadband Points, need to have an Active PCB, rest can be having inexpensive “Passive PCBs”. Not only does this almost halve the cost, it also halves the chain length for the Active PCBs, for powering the same number of Broadband Points. Lesser chain length, contributes to less electronic delay in Ethernet packet flow.

Further convenience is added by the fact, that the Active PCBs can come in various denominations, with its top panel supporting from one to four sockets, or even more. So even if one had started off with an Active PCB with one socket, one can replace it on the spot with another one with four sockets. The operation involves just plugging out the existing Active PCB from the Connection Strip, and plugging in the new Active PCB.

Thus, a Premise can have total peace of mind in expanding its usage from a few Broadband Points, to dozens of them. All this, without requiring any upfront planning or expenditure. Furthermore, there is no penalty for not even visualizing all the needs of the Broadband Points in the beginning, since new Broadband Points can be inserted as and when required

LAN Cabling without Requiring Network Technicians

The “structured LAN cabling” in offices, requires Network Technicians, to plan, install and execute the cabling, which has to conform to many networking guidelines. This is normally considered as out of scope of Electricians and Cable-TV technicians.

The invention, simplifies the cabling requirement to the extent that it would be as obvious as connecting a series of decorative bulbs in an electrical chain. The Broadband Points are inserted in the looped cable, in the same manner. Moreover, the task of cutting cables, exposing the copper wire, and inserting/crimping them inside the Broadband Points, is what would be simple enough for an Electrician, whose normal work demands handling of more complex connections.

The height of Beading becomes very small (½ inch to ¾ inch) due to the need for carrying only one UTP cable and a 3-wire Electrical cable. Laying this in a systematic manner at the skirting level, becomes a job quite suited for an Electrician.

DC Power Loop

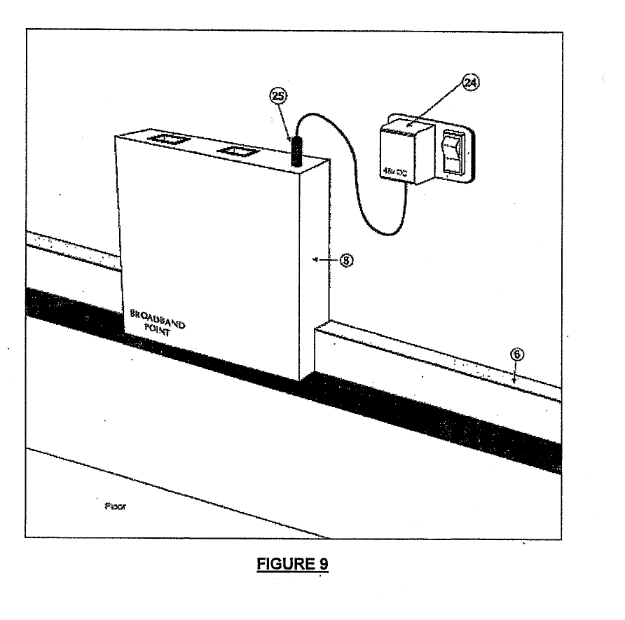

In an embodiment of the present invention, FIG. 9 shows how a 48V DC supply (24) is connected to a DC connector (25) on a Broadband Point (8). The 48V DC is then spread through a UTP pair inside the Beading (6), to provide power to all the Broadband Points and even the external Gateway.

The present invention provides convenient DC powering for Broadband appliances through Power-over-Ethernet (PoE). This 48V DC, PoE is meant to satisfy the modest power requirements, less than 15 watts, of appliances such as LCD TV, or Set-top-boxes. Most of the appliances thus don't have to worry about having an accompanying AC adaptor, which has to be separately plugged into a nearby Electrical Point. Moreover, the appliances can benefit from the battery backed DC power, during the AC power failures.

A battery-backed 48V DC power source, can be connected to any Broadband Point, for injecting power into it (through a separate DC connector). Because of the looped nature of the DC power cable, the electric resistance becomes much lesser than an equivalent length of the cable without looping. The worst case distance between the power source and an appliance decreases to half in a looped cable, while the resistance also becomes half since the current can come from both sides of the loop.

It is possible to add more DC power sources, as and when required, to satisfy the need of growing Broadband appliances. These distributed power sources can inject power onto the same bus. This even insures the appliances from any single failure of a power source;

The invention therefore enables a low entry cost, through a single DC power source and few Broadband Points. More can be added as and when required without any retrofit wiring.

AC Power Loop

Although 48V DC, is adequate for most Broadband appliance with less than 15 watt power requirements, this clearly is not adequate for PCs, TV Monitors, Game Boxes with hard-disk etc. These appliances require being plugged into the conventional electricity sockets.

It is very impractical to expect that existing Electrical sockets in the premise be found near the Broadband points. Even if they are, they might not be free. In most cases users have to use an Electrical extension board. This creates a bit of a mess on the floor, with wires lying loose, gathering dust. This mess makes the cleaning of the floor a difficult chore.

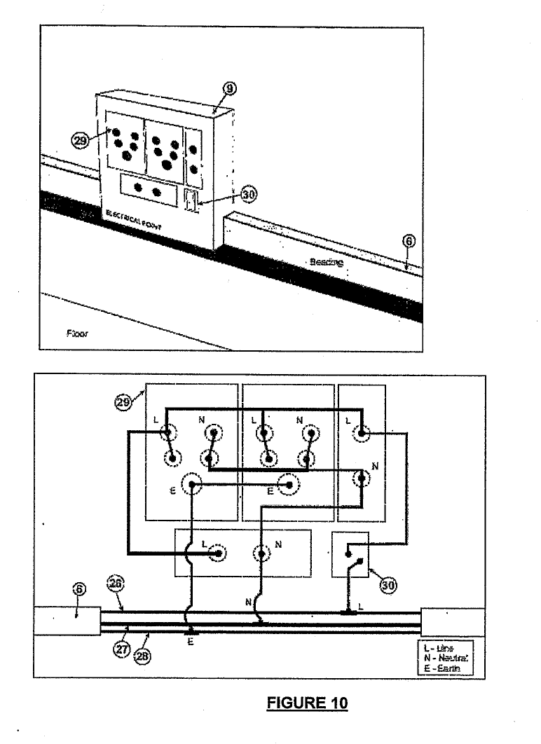

Therefore in an another embodiment of the present invention, there is a provision to have an Electrical Panel, located in front of the Broadband Point itself. This can sport three or four sockets, all of them connected through an MCB (Miniature Circuit Breaker) in the Electrical Panel itself. The FIG. 10 shows how the 3 Electrical wires (26, 27, 28) within an Electrical Point (9) can be connected to the Electrical Sockets (29). The Live wire (26) is routed through a MCB/Switch (30). So in case of any electrical problems one Broadband Point will not affect other Broadband Points. Alternatively a separate Electrical Point can be located next to a Broadband Point. For home usage, a Switch can replace the MCB.

The looped Beading supports three loops of Live, Neutral and Earth wires. These are attached at a specific location to the Main MCB of the premise. Thus the AC power in the entire Beading can be switched off through this Main MCB. Alternatively, the AC wiring can be also attached to an existing Power Socket (15 Amps) of the premise.

The gauges of the wires required for carrying the current is less than half than that for the total current requirement of the connected appliances. This is possible as the Electric current can reach an appliance through two different directions of the loop.

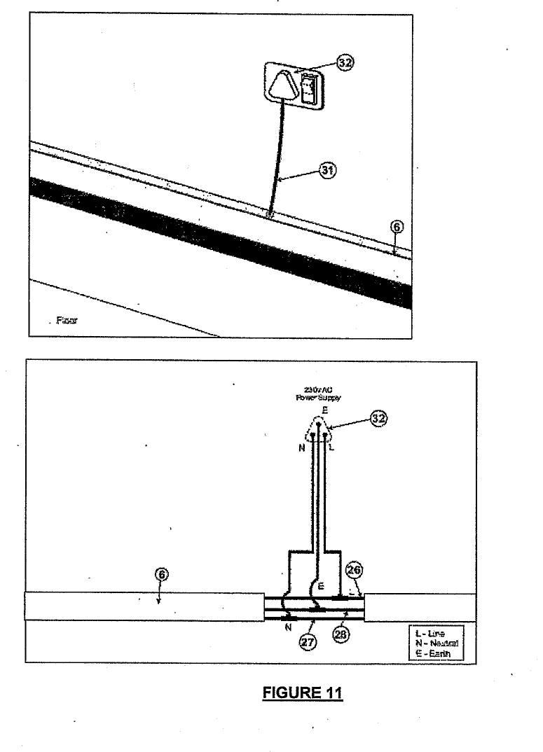

The Live, Neutral and Earth wires coming out of an Electrical Point are joined to the respective wires in the Beading. The joints are done without cutting any electic wire in the Beading. It is only necessary to remove a millimeter of the plastic coating on top of an electric wire, where a joint can be made to the bare end of the corresponding wire of the Electrical Point. An insulation tape needs to be put on the exposed joint. The FIG. 11 shows how the 3 Electrical wires (26, 27, 28) can at any suitable point (31) within the looped Beading (6) be connected to a 15 Amp socket of AC Mains (32) of the Premise.

The Broadband Points, with Electrical Points provide a neat way of connecting the most important appliances in a premise to an Uninterrupted Power Supply (UPS). A suitable capacity UPS can be used for providing AC power to the looped Beading. The UPS also provides back-up for the 48V DC power supply, ensuring that 48V DC also lasts as long as the batteries of the UPS.

Substantial cost saving can be achieved by using a low cost Invertor, in place of the on-line UPS. The only requirement, is that of a fast change-over time (under 50 ms), so that none of the Broadband appliances trip during the change-over.

The total amount of electrical cable required for connecting multiple points in a premise, is substantially lower, than that for the equivalent traditional method of bringing separate electrical wires from central MCBs in a premise (hub and spoke arrangement). The advantages here, parallels that of looped Ethernet cabling, over traditional hub and spoke Ethernet architecture.

The Sockets in the Electrical Points are fitted up-side down as shown in FIG. 10. This allows plug-points coming from devices above the table level, to be attached in a natural manner. A Cable manager is provide above a Broadband

Point to allow all the cables to be neatly routed, without the cables falling on the floor.

Thus a Broadband Home, with uninterrupted power for the appliances is easy to implement, low in cost, ergonomic and even aesthetic.

Recursive Wiring Procedure

The following methodology describes a “Depth First, Recursive Algorithm” for wiring an entire premise.

I. Premise-Wiring Procedure

Beading enters a Premise, through a Premise Door Frame at the Premise Entry Point (one of the top side edges of the Door Frame).

Make the Beading go down on side of the Door Frame, till it reaches the skirting level.

Follow the ROOM WIRING PROCEDURE (For this Room).

The Beading has come back at the skirting level to the other side of the Premise Door Frame. Now make it go over the Door Frame till it comes to the Premise Entry Point. Make the Beading go out of the Door Frame, to the outside of the Premise,

END OF PREMISE WIRING PROCEDURE

II. Room-Wiring Procedure (For a Room where the Beading is at the Skirting Level of a Door Frame).

If the Room is meant to be skipped for Beading, then go around the Door Frame, till you come to the skirting level. ROOM-WIRING PROCEDURE IS OVER.

Consider the Door Frame as the Main Door Frame.

LOOP

Continue the Beading at the skirting level till you encounter another Door Frame.

If the Door Frame is the same as the Main Door Frame then ROOM-WIRING PROCEDURE IS OVER.

If the Door Frame leads to a Room which had already been wired then go-around the Door Frame, and come back to the skirting level on the other side of the Frame. RESTART THE LOOP.

Make the Casing go through the Door Frame, at the skirting level, to the Connected Room. Follow the ROOM WIRING PROCEDURE (for the Connected Room, where Beading has entered).

Make the Beading come back from the Connected Room, through the Door Frame, at the Skirting Level to the present Room.

CONTINUE THE LOOP

END OF ROOM-WIRING PROCEDURE

Insertion of a Broadband Point, via Connection Strip

A Broadband Point is inserted at any point of the looped Beading at the skirting level. One has to cut the Capping of the Beading (which fits over the Casing of the Beading) at the insertion point and expose the underlying cables. The 5 pair UTP cable (4 pairs for Ethernet signals and one of 48V DC) is cut in the middle of the Broadband Point. These cut wires are then inserted into terminals on the left and right sides of a “Connection Strip”. The Connection Strip is then plugged into an Active or Passive PCB. The Broadband Point is fixed at the skirting level itself and hides internal wiring. Afterwards the Beading would appear as if it has gone right through the Broadband Point and then emerged on the other side.

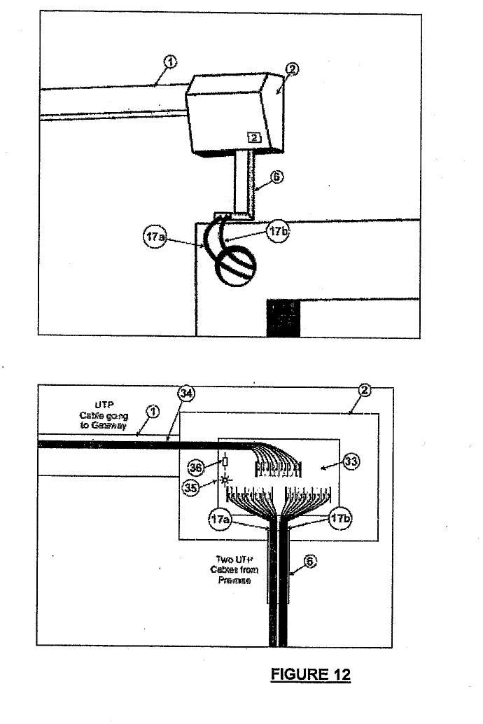

FIG. 12 shows how the two ends of the UTP cable (17a,b) coming from the Premise are terminated within the PCB (33) of the Premise Box (2). Each end in turn gets connected to a UTP cable (34) going to two halves of an external Gateway. A Premise LED (35) is connected to the 48V DC power coming from the Premise. A Diode (36) is used to link the 48V DC power coming from inside the Premise to the power pair on the UTP cable (34) going to the Gateway.

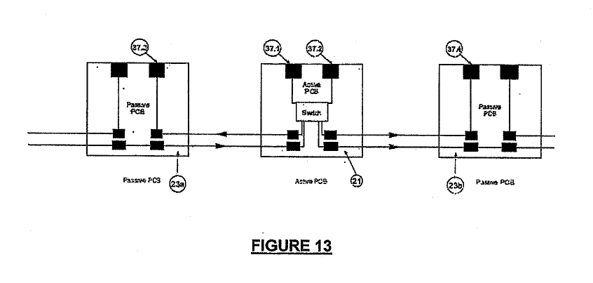

The FIG. 13 shows diagrammatically how an Active PCB (21) in one Broadband Point can supports two sockets (37.3, 37.4) on Passive PCBs (23a, b) of adjoining Broadband Points, in addition to its own sockets (37.1, 37.2).

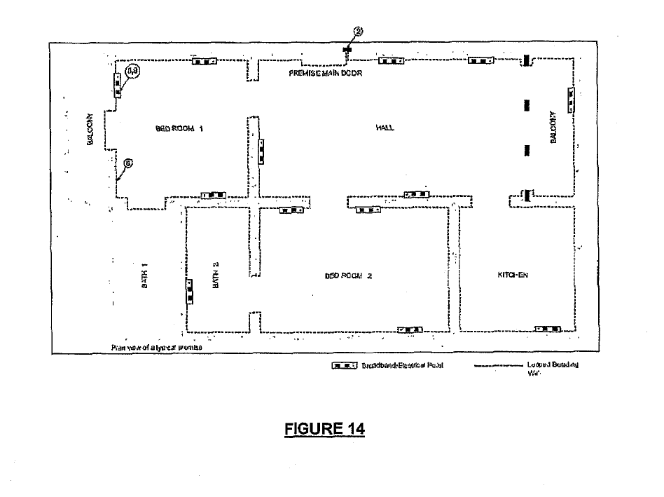

The FIG. 14 shows diagrammatically the recursively looped Beading (6) in a Premise, with Broadband Points (8) and Electrical Points (9) put in all the rooms. The Beading starts and ends at the Premise Box (2).

The Beading also contains AC wires (Live, Neutral and Earth). These wires don't have to be cut. Rather each wire's plastic coating is separated at a central point, to connect it to a corresponding wire of the Electrical Point. In addition the Live connection goes through a Miniature Circuit Breaker (MCB) or a Switch for providing electrical isolation.

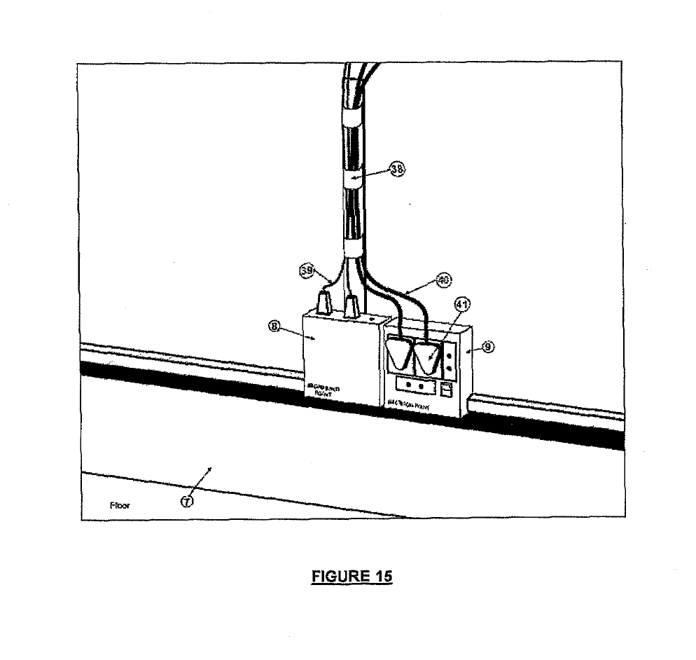

Further, the beauty of interiors also get marred by the loose cables hanging from table-top appliances to the plug-points at the skirting level. Most of the times these unruly cables spoil the looks of a wall, by dangling in front of it. Furthermore, the loose cables fall down to the floors and making cleaning the portion of floor, a difficult proposition. As a result, dust accumulates in the vicinity of these plug-points and with time the jumble of cable just increases, as more cables are brought down for connection. A neat way out of this dilemma lies in the use of a “Cable Manager” as shown in FIG. 15, along with each of the Broadband Point. The figure shows a Broadband Point (8) and Electrical Point (9) adjacent to each other. The Broadband Point in addition has a Cable Manager (38), through which the Ethernet cables (39) and Electrical cables (40) coming from a nearby desk-top are neatly routed to the sockets. Note that the Electrical sockets (41) are mounted in a reverse manner in the Electrical Point for convenience of routing.

The Cable Manager, guides the cables coming from the desk-top level neatly towards the sockets on the Broadband Points or Electrical Point. Furthermore, the Electrical sockets are mounted upside down, so that a plug can be inserted without the attached cable falling to the floor.

In the preferred embodiment of the present invention, a Five pair Unshielded Twisted Pair (UTP) cable is used for Ethernet/DC signals. Four pairs of UTP are used for carrying two Ethernet connections while one pair of the UTP is used for providing 48V DC power to Broadband Points and Broadband appliances. A three wire Electrical cable is used for providing AC power to the Electrical Points located on the Beading. These cables are enclosed within a Beading which goes mostly along the skirting level of the walls and covers each room on a recursive basis. Broadband Points can be inserted anywhere on the loop and at any time as per the emerging need. The looped Beading as mentioned above is dually connected to a Broadband Gateway. It ensures that a single failure of a Broadband Point, or a cable cut, does not hamper functioning of other Broadband Points.

The Electrical Points can be co-located along with the Broadband Points. These are connected to the AC cable bus, which has three wires for Live, Neutral and Earth. An MCB or an Electrical Switch is used to isolate the Live of an Electrical Point, from that of the AC cable bus.

In an embodiment of the present invention, the Broadband Points can be connected to existing Ethernet Appliances such as a PC, using standard Ethernet hook-up cables with RJ-45 connectors on both the ends. It can also be connected to new Broadband Appliances using a chord, as thin as that in telephony, and which while having RJ-45 connector on the Broadband Point side, uses the much smaller RJ-11 connector on the appliance side.

According to the present invention, the UTP cable carries two 100 Mbit Ethernet connections, each requiring 2 pairs of UTP cable. The “Primary” connection is used for chaining Gateway with Active Points. The “Secondary” connection is used for connecting an Active Point to the adjacent Passive Points.

As per the present invention, the Active Broadband Point has an Electronic PCB, with a few Ethernet Sockets. The Active Broadband Point also connects to the adjacent “Passive” Broadband Points, through the Secondary Ethernet connection. The Passive Broadband Points only have Ethernet Sockets. However, Power Over Ethernet (PoE), is locally inserted in the sockets of both Active and Passive Broadband Points.

The advantage of using a methodology of the present invention lies in its simple-minded scheme, which requires no planning skills and which can be implemented by an Electrician. No network diagrams are necessary for installation or maintenance.

Further advantages of the present invention are:

Providing a scheme which allows getting started with a few Broadband Points, while assuring that more Points can be inserted as and when required, without requiring any additional wiring.

The scheme also allows more DC powers to be added as the load of the Broadband Appliances increases.

Making a robust, failsafe infrastructure, which, unlike electrical infrastructure, can tolerate a cable cut, or a Broadband Point failure.

Allowing Broadband Appliances to have connectors and chords as small as those in normal telephones.

The above description is included to illustrate embodiments of the present invention and is not meant to limit the scope of the invention. Those having skill in the art will recognize additional modifications and embodiments and it will be apparent that any modification and variation may be effected without departing from the scope of the novelty of the present invention.

### INDEX OF TERMS

(Italicized terms are specific to this invention)

48V DC

DC voltage commonly used in telephone and telecom infrastructure for powering equipment. During power failure the same voltage is provided by a bank of 48V batteries.

AC—Alternating Current

Used for supplying electricity to homes and offices. Unlike DC (Direct Current), the polarity of the current alternates in each wire at 50 cycles per second (60 in USA).

Active Broadband Point

Has “active” Switch electronics inside. The Switch is connected to Ethernet Sockets, as well as UTP cables on both sides of the Broadband Point.

ADSL—Asymmetric Digital Subscriber Line

A technology which allows existing phone lines to be used for transmitting digital data at 2 Mbit/sec or higher rate.

Beading

Term for a small Casing&Caping (¾ inch or less), which essentially is kept at the skirting level of a premise. This way it looks like a “beading” on top of the skirting.

Broadband

A term which indicates digital data lines which are capable of transmitting live TV channels.

Broadband Appliances

Like Electrical Appliance, these can be plugged into a Broadband Point, and provide digital audio/video interfaces.

Broadband Point

Like an Electrical Point, this provides Ethernet sockets for allowing Broadband Appliances to be plugged in. It also some appliances to be powered through the modest power available on the socket itself.

Cable Manager

Is a transparent vertical cable guide, which is fitted above a Broadband Point, and allow Ethernet and Electrical cables to be supported, so that they don't fall on the floor.

Casing & Capping

Used for concealing the traditional UTP and Electrical wiring. Casing is fitted on the wall using nails, and guides the cables. The Capping is manually clipped on to the Casing, for concealing the cables and preventing them from falling out.

Connection Strip

Is a small PCB strip, almost as wide as the Broadband Point. It has a central connector on the rear side, for allowing it to be plugged on to an Active or Passive PCB. On the front side it has 10 terminals on each of the sides. A 5 pair UTP cable (containing 10 wires) can be terminated on one side of the strip.

DC—Direct Current

Is what is supplied by batteries, and what is ultimately required by all electronic PCBs. The AC supply at premises has to be converted to DC before it can power any electronic PCBs.

Dual Gateway

Provides redundancy, with two Gateway PCBs. Each premise is now dually connected to each PCB. In this case, even if one PCB fails, the Ethernet connection from the other is still available.

Earth Wire

Is a wire, which allows sinking of a current to the “earth”, and thus provides safety. The earth wire is normally connected to the metal body of an appliance, through the bigger pin of a three wire electrical plug.

Electrical Point

Like the Broadband Point, the Electrical Point also is placed on the looped Beading at the skirting level, and provides a few Electrical sockets. It is located adjacent to a Broadband point for convenience.

Ethernet

A protocol which defines how the raw data packets flow on a network link. The link can be using coaxial cable, twisted wires, or fibre optics. Ethernet allows a Local Area Network to be set up for connecting PCs and other Ethernet devices (such as printers). Today, Ethernet today is being used in Broadband Networks for connecting all devices world-wide.

Gateway

Gateway serves as a demarcation point between a Broadband network and the Local Area Network in a Premise(s). It has a Firewall to provide security to premises as well as the Broadband network. It provides address translation facility, from private addresses in the premises to global addresses in the Broadband Network.

Invertor Power Supply

Similar to UPS. When the power fails it generates from battery an Alternating Current which is in form of a Square wave, instead of a Sine wave (as available from the main AC supply). It also, takes around 50 millisecond or more to switch from main AC supply. It, however, is much more cost effective than a UPS, and adequate for Broadband appliances.

LAN—Local Area Network

Provides Ethernet sockets, for allowing PCs and other Ethernet devices to communicate to each other. Traditionally this is achieved by having a central Switch, connecting each Ethernet socket in a premise through a separate Ethernet cable.

Live Wire

In the Electrical wiring, this wire has 220V (or 110V) potential compared to ground, and can thus give an electric shock. This, wire is routed through a Switch or MCB, so that an appliance can be isolated from the live electric current.

MCB—Miniature Circuit Breaker

This device is used for routing the, Live wire to an appliance. In case of any overloading in the appliance, the device “trips”, thereby disconnecting the live current. Unlike a “fuse”, the MCB can be reset, after the overloading is removed.

Neutral Wire

An electric appliance is connected between Neutral wire and the Live wire. Neutral wire is generally safe to touch, as it has the same potential as earth.

Passive Broadband Point

Is a low cost Broadband Point, which provides Ethernet Sockets without having any electronics PCB. Each Ethernet socket gets actually connected through a Secondary connection to an adjacent Active Broadband Point. The PoE is, however, locally injected into the Ethernet Sockets.

PCB—Printed Circuit Board

Is usually a Green colored board with Electronic chips mounted on them. The Electronic chips and Connectors are connected through copper tracks on the board. Passive PCBs don't have sophisticated electronic chips.

PoE—Power over Ethernet.

The original Ethernet used a 4 pair connector for signals, but no power was available through this. The new PoE standard, allows a 48V (13 Watt), power to be supplied through two of the pairs. The PoE socket has to sense, whether it is connected to a device which can use PoE power, before it switches on the power.

POTS—Plain Old Telephone System

Is the century old Telephony system, which remains essentially unchanged even today. POTS term is used whenever a contrast has to be made with any modern variant.

Primary Ethernet Connection

Uses the first two pairs (Blue pair and Orange pair) of a four or five pair UTP cable. These two pairs can carry a 100 Mbit Ethernet signal, between a Gateway to an Active Broadband Point, or between two Broadband Points.

RJ11

Is the small 2 or 4 wire connector usually found in telephone instruments. It is small in size, and can indeed be embedded “out of sight” in the instrument itself.

RJ45

Is the standard 8 wire connector used for connecting Ethernet appliances. It is bigger than the RJ11 connector. The RJ-11 plug can though go inside a RJ-45 socket and connect to the 4 central wires.

Secondary Ethernet Connection

Uses the second two pairs (green pair and brown pair) of a four or five pair UTP cable. These two pairs can carry a 100 mbit ethernet signal, from an active broadband point to an adjacent passive broadband point.

STP—Spanning Tree Protocol

Is the traditional protocol used in Ethernet LANs for preventing packets to circulate around endlessly in a loop, which might be present in a LAN wiring. It, however, puts a limitation on number of switches, which can be chained. It also takes a few minutes to figure out alternative connection when a link or switch fails.

UPS—Uninterrupted Power Supply

When the main AC power fails, it generates a similar AC voltage using its batteries. An “on-line” UPS, furthermore, always generates AC from its batteries (which are charged in the background), so that there is no switching delay when the power fails. These robust provisions also makes it costly compared to Invertors.

USB—Universal Serial Bus

A popular standard for connecting peripherals to a PC. The small connector has two wires for serial communication and two for providing a very modest 5 Volts supply to the peripheral. This may be adequate for small devices such as mouse, keyboard, and memory stick.

UTP Cable—Universal Twisted Pair Cable

Consists of pairs of cables which are twisted together. One wire of the pair is given a specific color, this is the signal wire; the other is given a white color and is the return-signal wire. A cable can carry many twisted pairs, as they don't cause signal interference, over a specified length. The UTP standard adequate for a 100 Mbit Ethernet signal is called CAT-5.

VoIP—Voice Over IP

In traditional POTS telephony, the voice is carried as analog current. In digital telephony, the voice is digitized first and then carried as packets. These packets are in the format of Internet Protocol (IP). Thus VoIP, allows telephone communication on a LAN or Broadband network.

WiFi—Wireless Fidelity

Is the popular standard, which uses a public wireless spectrum to allow WiFi devices to access the internet through a WiFi Access Point. Up to 50 Mbits of shared bandwidth is available in a small area of around 50 metres.

WAN—Wide Area Network

While Local Area Network (LAN) stay within a Premise or a Building, WAN can cover a campus or even a city.

1. A method for Ethernet and electrical power cabling comprising:
providing wiring to a building through an entry point;
providing wiring in at least one room of the building at a skirting level;
wherein the wiring includes at least a broadband point, at least a pair of Ethernet cables, and at least a pair of electrical cables forming a recursive loop beading.

2. The method for Ethernet and electrical power cabling as claimed in claim 1, wherein the loop beading includes at least one Broadband Point the method further comprising:
increasing the number of the broadband points to form a series of broadband points.

3. The method for Ethernet and electrical power cabling as claimed in claim 1, wherein said broadband point further includes at least one Power over Ethernet (PoE) socket, a passive Printed Circuit Board (PCB), and an active PCB.

4. The method for Ethernet and electrical power cabling as claimed in claim 3, further comprising:
cutting the Ethernet cable at the center of the Broadband Point and inserting bare ends of the cable on terminals on the two sides of a Connection-strip.

5. The method for Ethernet and electrical power cabling as claimed in claim 1, further comprising passing the Ethernet cable through a dummy Broadband Point having no PCB or sockets.

6. The method for Ethernet and electrical power cabling as claimed in claim 3, wherein the Active PCB supports at least two sockets on Passive PCBs of the two adjacent Broadband Points, without using any additional cable for connections.

7. The method for Ethernet and electrical power cabling as claimed in claim 1, wherein said Ethernet cable further includes a DC loop being powered by DC adaptors attached at one or more Broadband Points.

8. The method for Ethernet and electrical power cabling as claimed in claim 1, wherein said looped beading further includes an AC power loop.

9. The method for Ethernet and electrical power cabling as claimed in claim 1, wherein the series of Broadband Points is extended on a Dual Gateways located outside the building.

10. The method for Ethernet and electrical power cabling as claimed in claim 9, further comprising powering the Dual Gateway solely from the DC loops of the building and keeping the Dual Gateway “ON” as long as any of its premises in “ON”.

11. The method for Ethernet and electrical power cabling as claimed in claim 1, further comprising mounting the electrical sockets upside-down.

12. The method for Ethernet and electrical power cabling as claimed in claim l, further comprising holding the Ethernet and electrical cables by at least one transparent cable guide.

13. The method for Ethernet and electrical power cabling as claimed in claim 1, wherein the loop beading, includes alternate Broadband Points having an Active PCB, with others having Passive PCBs with one or two Ethernet Sockets.

14. The method for Ethernet and electrical power cabling as claimed in claim 1, wherein upon insertion of each broadband point, the Active and Passive PCBs are shuffled within the Broadband Points and preserve the alternating sequence.

15. The method for Ethernet and electrical power cabling as claimed in claim 2, further comprising adding new broadband points without additional cabling.

16. The method for Ethernet and electrical power cabling as claimed in claim 3, further comprising arranging broadband points comprising active and passive PCBs in alternating sequence.

17. The method for Ethernet and electrical power cabling as claimed in claim 7, wherein the DC loop is 48V, the method further comprising supplying, via the DC loop, power to the Power-over-Ethernet (PoE) sockets and the Active PCBs in the Broadband Points.

18. The method for Ethernet and electrical power cabling as claimed in claim 8, further comprising drawing AC power from electric sockets adjacent to the broadband points via a miniature circuit breaker (MCB) or switch.

19. The method for Ethernet and electrical power cabling as claimed in claims 7, further comprising displaying the status of the electrical supply.

20. The method for Ethernet and electrical power cabling as claimed in claim 1, further comprising adding broadband points to a segment along the beading by slitting the Ethernet cable and connecting the cable to the terminals of the connection stripe of the additional broadband point.

21. The method for Ethernet and electrical power cabling as claimed in claim 1, further comprising burying the looped beading in a groove directly above the skirting.

22. The method for Ethernet and electrical power cabling as claimed in claim 1, further comprising providing wiring at a crown molding level of the building.

23. A method for inserting a broadband point comprising:
slitting an Ethernet cable;
inserting the bare ends of the Ethernet cable into terminals of a connection strip;
connecting the connection strip to one of a passive PCB and active PCB having at least an Ethernet socket;
installing the Ethernet cable at a skirting level of a building.
